(19) United States
(12) Patent Application Publication
(10) Pub. No.: US 2006/0141110 A1
(43) Pub. Date: Jun. 29, 2006

(54) Method for producing particles

(76) Inventors: Jacques Fages, Albi (FR); Jean-Jacques Letourneau, Gragnague (FR); Philippe Gonus, Haxby (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/536,038

(22) PCT Filed: Nov. 21, 2003
(86) PCT No.: PCT/FR03/03457

§ 371 Date: Nov. 9, 2005

(30) Foreign Application Priority Data
Nov. 21, 2002 (FR) 0214586
Jul. 29, 2003 (FR) 0309310

(51) Int. Cl. A23L 1/00

(52) U.S. Cl. 426/285

(57) ABSTRACT

The invention concerns a method for producing particles (20, 21) at least partly crystallized, under pressure, comprising reciprocal dissolving of at least one fluid under higher or slightly lower pressure than its critical pressure with at least one substance to be treated, in a dissolving zone (2), followed by rapid depressurization with at least one depressurizing means (12) downstream of said dissolving zone (2) so as to collect said particles (21), at least partly crystallized, in the collecting zone (3) located downstream of said depressurizing means (12), said substance to be treated comprising the butterfat. Said method is characterized in that it further consists in collecting particles (20) at least partly crystallized in the dissolving zone (2). The invention also concerns a device (1) for implementing said method.

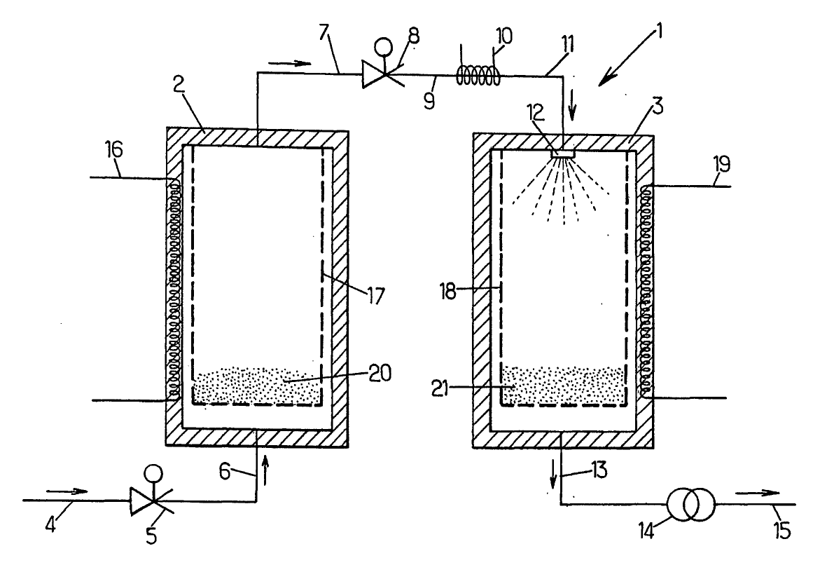

The invention relates to a method for producing particles or divided solids generally in powder form, comprising at least partially crystallized fat, in particular for producing crystals of fat, for example and preferably of cocoa butter. The invention further relates to a method for producing particles or divided solids generally in powder form, comprising at least fat, for example chocolate powder which contains cocoa butter, sugar and other materials, fatty or not, of plant or animal origin. The invention further relates to a device for putting such a method into practice.

Cocoa butter is a polymorphic fat that can crystallize in various forms (see for example “Les performances du beurre de cacao dans le chocolat”, Industries Alimentaires & Agricoles, December 2001, p. 11-14). The various crystalline forms include: γ (or form I), α (or form II), β′2 (or form III), β′1 (or form IV), β2 (or form V) and β1 (or form VI). The thermodynamic stability and melting point increase from form I to form VI. Although metastable (very slow transition toward the stable form VI in normal temperature and pressure conditions), form V, for organoleptic reasons, must be the majority form in the chocolate. In fact, form VI gives a rather dull and undesirable appearance to the chocolate.

Crystalline particles of cocoa butter or chocolate can serve as seeds for producing chocolate during a tempering step. The tempering comprises, in succession, a liquid chocolate cooling step, followed by a heating step to remove the forms from I to IV. The tempering must allow the appearance of the largest possible number of form V crystals, to guarantee rapid and perfect crystallization mainly in metastable form V. This serves to impart better quality to the chocolate thus produced. To further improve this crystallization, it is possible, in a particular embodiment of the prior art, which is little used, to seed form V with cocoa butter.

To carry out this actual tempering, the liquid chocolate is cooled in the usual manner to about 20-25° C. to cause the appearance of crystals of cocoa butter. Crystals of all the forms generally appear, including crystals of unstable forms. The seeding by crystals of form V, according to the particular embodiment of the prior art diskussed above, can serve to limit this occurrence. The mixture is then generally heated to about 30° C. to melt the crystals of form I to IV, leaving only crystals of form V and, if possible, practically always none of form VI. After a certain time interval, during which the crystals of form V are generally allowed to grow and proliferate in a controlled manner, thereby causing the formation of seeds in situ (without seeding by the addition of external material), the chocolate thus produced is normally sent to the rest of the chocolate manufacturing process (molding in bars, etc.).

The crystals of cocoa butter needed for the seeding during tempering, according to the particular embodiment of the prior art diskussed above, are generally obtained by a mechanical method, for example by grinding into grains. In this case, the crystals thus obtained do not have the desired crystalline polymorphic form, and have a morphology that is unsuitable for seeding, because the surface of the grains is spoiled and/or crushed by such a mechanical production method. More recently, the use of a method of the PGSS type (for “Particles from Gas Saturated Solutions”) has been described for producing crystals of cocoa butter in the form of a fine powder of crystals: “S-L-G (Solid-Liquid-Gas) phase transition of cocoa butter in supercritical CO₂”, Acta alimentaria, vol 28 (2), pp 197-208 (1999) and “High Pressure Process Technology: Fundamentals and Applications”, paragraph 9.8.7.2 “Cocoa butter”, p. 603-604, Industrial Chemistry Library, Vol. 9 (2001). Such a method consists of the production of fine particles from gas-saturated solutions, which starts with the dissolving of a fluid in the substance to be produced, previously melted. The gas-saturated solution is then expanded, causing the particles to crystallize. The crystals thus obtained are mainly in form VI with a melting point of about 36-37° C., whereas, as explained above, it is preferable to have a morphology of form V crystals, with a melting point of about 33° C., for the industrial production of chocolate. Accordingly, there remains a need to develop a method for producing particles, in particular of crystals of cocoa butter, permitting the recovery of the maximum possible number of crystals, preferably crystals of form V, and of the best possible quality, that is, practically pure in terms of crystal lattice. The method according to the invention advantageously serves to meet this need.

The method according to the invention is a method for producing particles at least partially crystallized, under pressure, comprising reciprocal dissolving of at least one fluid under higher or slightly lower pressure than its critical pressure, with at least one substance to be treated, in a dissolving zone, followed by rapid depressurization with at least one depressurizing means, downstream of the dissolving zone, so as to collect said particles, at least partially crystallized, in a collecting zone located downstream of said depressurizing means, said substance to be treated comprising fat, said method being characterized in that it further comprises a collecting of particles at least partially crystallized, in the dissolving zone.

The particles collected in the collecting zone and in the dissolving zone, at least partially crystallized, are particles that may comprise various materials including fat, which, according to the invention, is mostly, and preferably almost completely, crystallized. Said particles, particularly where the substance to be treated is chocolate, further comprise other components. Where the substance to be treated is cocoa butter, said particles are crystals of fat that is cocoa butter.

Typically, said collecting takes place after the depressurization that has led to a crystallization of the fat of said particles.

The substance to be treated generally contains from 10 to 100% of fat, preferably from 20 to 50% where the substance to be treated is chocolate.

According to the invention, the substance to be treated is the substance as present in the dissolving zone. It is in solid and/or liquid form. For example, it is in solid form and at least partially in melted, liquid form. Thus if the substance to be treated is chocolate, and is introduced into the dissolving zone in melted form, it contains particles in suspension, and only the fat is liquid. The method according to the invention can also comprise at least one prior step of the introduction of said substance to be treated into the dissolving zone. Said prior introduction step is carried out in a conventional way, known to a person skilled in the art.

The dissolving is qualified as reciprocal, because substance to be treated in solid and/or liquid form dissolves in the fluid and simultaneously, fluid dissolves in the substance to be treated if the latter is liquid. This reciprocal dissolving can, depending on the operating conditions, give rise to the presence of a single homogeneous fluid phase, or to the coexistence of two fluid phases in equilibrium. If the substance to be treated is chocolate that does not contain only fat, insoluble particles, such as, for example, particles of sugar and/or sweetener are dispersed in the fluid. In fact, chocolate generally comprises numerous ingredients of which the main ones are cocoa butter and sugar. It may also comprise at least one flavor, starch, cellulose and other materials originating from the cocoa beans. Finally, it may contain other ingredients including other fats, for example, butterfat if the substance to be treated is milk chocolate. One speaks of chocolate particles when the chocolate is generally solid in powder form, regardless of its composition. Its fat is then preferably at least partially crystallized in accordance with the invention.

Said depressurizing means is preferably an expansion nozzle.

Advantageously, and surprisingly, such a method serves to collect, in the dissolving zone, particles in which the fat content is practically only of a single crystalline polymorphic form, and with a high specific surface area.

Advantageously, and surprisingly, such a method serves to collect particles of sufficiently good crystalline quality in the solid state for use as seeds in a method for using such particles. If the substance to be treated is cocoa butter, the crystalline particles obtained have an angular appearance and a particle size generally smaller than 20 μm and possibly smaller than 1 μm. Accordingly, and surprisingly, the method according to the invention is particularly advantageous for recovering particles of cocoa butter of a crystalline form V. If the substance to be treated is chocolate, extremely fine particles are usually and advantageously recovered, that is, particles smaller than 50 μm, and very uniform. The fat present in these chocolate particles generally consists mostly of cocoa butter of crystalline form V.

According to the invention, “collecting” means that one can then directly recover the particles available, from these dissolving and collecting zones, or that these particles are used directly, because they reach a collecting zone in which they can directly serve as seeds in the tempering step of chocolate production.

Thus according to a particular embodiment of the method according to the invention, the particle collecting zone is a conversion zone in which fat is tempered (or crystallized). Typically, in a chocolate producing method, this may be the zone in which the tempering is carried out. The particles then serve to seed the mass of liquid chocolate. The method according to the invention is then advantageously a continuous method, which can advantageously be put into practice in a (standard) method for tempering chocolate. According to the invention, continuous method means a method that can operate continuously, as opposed to a “batch” method.

According to an embodiment of the invention, the fluid contains at least one chemical or cosolvent compound, which is used to increase the solvent power of the supercritical fluid. Such a cosolvent is generally added to the fluid in a quantity of 1 to 5% by weight, and is, for example, an alcohol such as ethanol.

According to an embodiment of the invention, the fluid, in gaseous form after depressurization, and the particles, generally in solid form, are separated in the collecting and/or dissolving zone. Said separation can consist simply and advantageously of a recovery of the gas, for example, by ventilation to remove the gas from the collecting and/or dissolving zone.

The pressurized fluid is generally selected from the group formed from carbon dioxide, short-chain alkanes that is generally comprising 1 to 4 carbon atoms per molecule, nitrous oxide and nitrogen, and mixtures thereof, and preferably, said pressurized fluid is carbon dioxide. Such a pressure is generally between 70 and 350 bar (7 to 35 MPa), preferably between 200 and 300 bar (20 to 30 MPa), for example equal to about 250 bar (25 MPa).

In a preferred embodiment of the method according to the invention, said pressurized fluid is in the supercritical state, that is, at a temperature above the critical temperature and at a pressure above the critical pressure. For example, in the case of carbon dioxide, the temperature is equal to or higher than the critical temperature, which is 31.1° C., and the pressure is equal to or higher than the critical pressure, which is 73.8 bar (7.38 MPa). For example, in the case of nitrous oxide, the temperature is equal to or higher than the critical temperature, which is 36.5° C., and the pressure is equal to or higher than the critical pressure, which is 72.4 bar (7.24 MPa).

In another preferred embodiment of the method according to the invention, said pressurized fluid is in the subcritical state, such that the (operational) temperature is slightly lower than the critical temperature, that is, has a value between 0.9Tc and Tc, where Tc is the critical temperature, and the pressure is higher or slightly lower than the critical pressure. For example, in the case of carbon dioxide, the temperature is lower than 31.5° C. and the pressure is higher than 73.8 bar (7.38 MPa), and preferably higher than 200 bar (20 MPa). For example, in the case of nitrous oxide, the temperature is lower than 36.5° C. and the pressure is higher than 72.4 bar (7.24 MPa), and preferably higher than 150 bar (15 MPa).

According to a preferred embodiment of the method according to the invention, the temperature and/or pressure in the dissolving and/or collecting zone is controlled so that, during said method, the pressurized fluid does not crystallize during the expansion (depressurizing) step and that, furthermore, the at least partially crystallized particles do not melt. Typically, for example, the temperature in the dissolving zone is controlled so that, during said method, the pressurized fluid does not crystallize during the expansion step and that, furthermore, the at least partially crystallized particles do not melt. Thus in the case of the production of crystalline particles of cocoa butter alone or in chocolate particles, with carbon dioxide, the temperature of said dissolving zone is generally maintained below about 30° C. and above about 20° C.

According to a preferred embodiment of the method according to the invention, the contact time in the dissolving zone is adjusted so that the maximum possible amount of substance to be treated is solubilized. This advantageously serves to ensure maximum profitability from the method according to the invention.

According to a variant of the method according to the invention, to promote the dissolving, substance to be treated is placed in excess in the dissolving zone before the method according to the invention is put into practice. In this case, the unsolubilized excess in the dissolving zone is recovered after the method according to the invention is put into practice. In the case of the production of crystallized particles of cocoa butter, from a substance to be treated which is cocoa butter, and in which an excess of cocoa butter is advantageously placed in the dissolving zone before the method according to the invention is put into practice, it is particularly easy, in the remainder of the method according to the invention, to separate the yellowish pieces of unsolubilized cocoa butter from the fine white and light powder, consisting of the crystals of cocoa butter that have been produced.

According to another variant of the method according to the invention, independent or not of the preceding variant, at least one stirring means is used to stir the substance to be treated and the fluid during their reciprocal dissolving in the dissolving zone so as to promote the dissolving, before the depressurization. If the substance to be treated is chocolate, this variant advantageously serves to homogenize the solid-fluid mixture.

In the preferred case according to the invention in which the substance to be treated is cocoa butter and carbon dioxide in the supercritical state is used, about 1% by weight of cocoa butter is generally dissolved in the carbon dioxide in the supercritical state, depending on the pressure and temperature conditions.

The invention further relates to particles that can be precipitated by a method according to the invention. If the substance to be treated consists almost completely of cocoa butter, such particles advantageously and singularly have a particular morphology under the environmental scanning electron microscope (or ESEM), in that the crystals are angular and in that their particle size distribution is generally between a few hundred of nanometers and some 20 microns.

The invention further relates to the use of a method as described previously, for producing particles of which the fat is at least partially, and preferably mostly, and even more preferably almost completely, crystallized, and preferably for producing crystallized particles of cocoa butter, generally alone or in particles of chocolate.

In a particularly advantageous manner, such a method thereby serves to recover particles of which the fat is mostly (more than 90% by weight) of form V to serve as seeds in a subsequent tempering method. In particular, the subsequent tempering method, which uses said particles and/or in which the method according to the invention is put into practice, serves to use a smaller quantity of seeds compared with the quantities of the prior art, or typically about 0.1% by weight instead of a few % by weight used according to the particular embodiment of the prior art diskussed previously (see for example “crystallizing the fat in chocolate”, p91 in “The Science of Chocolate”, by S. T. Beckett, RSC Paperbacks, Cambridge UK). The seeding can also be carried out at a higher temperature than the usual 30° C. of the usual prior art (without seeding by input of external material), for example at about 32° C. Such a possibility serves advantageously to work in tempering on a less viscous paste than the paste usually worked, resulting in a saving of energy for stirring and greater ease of handling for the paste flows. And finally, the cooling step normally carried out during the tempering of the chocolate can be advantageously shortened. The tempering step is also generally carried out in a much shorter time than conventionally, advantageously in 4 to 5 minutes instead of the normal 30 minutes of the usual prior art, which results in a dual saving of time and energy.

The invention further relates to a device for producing at least partially crystallized particles under pressure, comprising at least a first reactor for reciprocal dissolving of at least one substance to be treated with at least one fluid under a higher or slightly lower pressure than its critical pressure, followed by at least one depressurizing means, downstream of the first dissolving reactor, which supplies at least a second reactor for collecting at least partially crystallized particles, downstream of said depressurizing means, said device being characterized in that the first dissolving reactor is also a reactor for collecting at least partially crystallized particles.

According to an embodiment of the invention, said second reactor is a reactor in which at least a conversion of a substance to be treated can take place, for example, during a chocolate tempering step. Such a reactor is preferably able to operate continuously.

According to an embodiment of the invention, said device comprises at least one stirring means in the first reactor. Such a stirring means is typically a bladed turbine of the Rushton module type, comprising a horizontal disk and at least two blades that can be tilted. Such a stirring means is not obligatory according to the invention but advantageously improves the dissolving in the first reactor.

According to an embodiment of the invention, said device comprises at least one means for mixing a cosolvent with the fluid.

Preferably, said crystallization takes place by depressurization using at least one depressurizing means. Preferably, said depressurizing means is an expansion nozzle.

Preferably, the depressurizing means is selected so as to adjust the depressurization time.

The device according to the invention is hence ideal for putting the method according to the invention into practice.

The device according to the invention is ideal for producing crystals of fat, and in particular and preferably for producing crystals of cocoa butter, generally alone or in chocolate. Thus the device according to the invention is ideal for producing chocolate particles. The definition of chocolate particles has been given previously.

Cocoa butter is a fat extracted from cocoa, or from cocoa paste by mechanical pressure. This cocoa butter generally mainly consists of three triglycerides, which are glycerol 1,3-dipalmitate 2-oleate or POP, glycerol 1-palmitate 2-oleate 3-stearate or POS and glycerol 1,3-distearate 2-oleate or SOS. Crystals of cocoa butter can advantageously serve as seeds for producing chocolate by tempering as explained previously.

The invention will be better understood and other features and advantages will appear from a reading of the description that follows, which is nonlimiting, with reference to the FIGURE appended hereto.

The FIGURE schematically shows a device 1 for producing at least partially crystallized particles 20, 21 according to the invention.

A line 4 followed by a line 6, after passage through a valve 5, are used to supply the first of the two successive reactors 2 and 3 shown in a cross section, with a fluid under higher or slightly lower pressure than its critical pressure. The reactors 2 and 3 are typically solid stainless steel autoclaves. The valve 5 is used to shut off the supply of said fluid whenever necessary. The reactor 2 is a reactor for dissolving a substance to be treated with a pressurized fluid, and is used according to the invention for collecting at least partially crystallized particles 20. Typically, before the method according to the invention is put into practice, the reactor 2 comprises the substance to be treated and the putting into practice of said method begins with the input of said fluid. To promote the dissolving of said fluid and of the substance to be treated, the reactor 2 advantageously comprises the presence of a stirring means 22, for example a Rushton turbine, comprising, at the end of a shaft 22a passing through said reactor 2, a horizontal disk 22b, shown in a cross section in the FIGURE, and blades 22d and 22c. The reactor 3 is a reactor for collecting at least partially crystallized particles 21. The reactor 2 is equipped with heating means 16, which is a heating resistor. The reactor 3 is equipped with heating means 19, which is a heating resistor. The reactors 2 and 3 each comprise an internal basket respectively 17 and 18 typically of porous (sintered) stainless steel, facilitating the collecting of the particles produced. The reactor 3 is supplied with a fluid mixture via a line 7 that issues from the reactor 2, then becomes a line 9 after passage through a valve 8, then becomes a line 11 after heating by heating means 10, which is a heating resistor. The line 11 terminates in the reactor 3 via a depressurizing means 12 which is typically an expansion nozzle. From the reactor 3 issues a line 13 for withdrawing product, which becomes a line 15 after passage through a weir 14. The weir 14 serves in particular to control the pressure in the second reactor, to generally maintain a pressure that is lower, preferably much lower, than the pressure of the first reactor 2 but is equal to or higher than the atmospheric pressure.

Some substance to be treated (not shown) is present in the reactor 2 before the production of particles 20 and 21. When the method according to the invention is put into practice, some substance to be treated is placed into the reactor 2, which is insulated. The valve 5 is then opened to introduce pressurized fluid via the lines 4 and then 6, which under the temperature and pressure conditions of the first reactor 2, permit the at least partial reciprocal dissolving of said substance with said fluid, during a contact time, said dissolving being promoted by the rotation of the turbine 22. The fluid mixture produced is heated during the passage from the first reactor 2 to the second reactor 3, using heating means 10. The valve 8, which was initially in the closed position, is opened so that the fluid mixture issuing from the first reactor 2, passing through the lines 7, 9 and 11, and then the spray means 12, flows into the second reactor 3, undergoing a generally extremely rapid depressurization. This depressurization leads to the formation by crystallization of solid forms of the substance to be treated, which are particles 21, that can be recovered after crystallization. Heating by the heating means 10 upon the opening of the valve 8 advantageously serves to avoid the formation of dry ice after depressurization. At the same time, a slow depressurization takes place in the first reactor 2. This leads to the formation by crystallization of crystallized solid forms of the substance to be treated, which are particles 20, that can be collected after crystallization. According to one embodiment of the method according to the invention, it is simultaneously possible to carry out a controlled opening of the valve 5 so that the pressure in the first reactor 2 remains practically constant. In any case, the crystallization of the particles 20 in the first reactor 2 takes place during the depressurization of said reactor 2.

The example below illustrates the invention without necessarily limiting its scope.

### EXAMPLE

### Precipitation of Cocoa Butter Dissolved in Carbon Dioxide in the Supercritical State

In the following example, a device 1 as previously described is used. The fluid under higher or slightly lower pressure than its critical pressure is carbon dioxide. Its supercritical state corresponds to a state in which its temperature is above 31° C. and its pressure is above 74 bar (or 7.4 MPa). Under these conditions, the substance to be treated, which is cocoa butter comprising 97% of triglycerides according to the following distribution: 12 to 18% of POP, 36 to 46% of POS and 21 to 30% of SOS, and 10 to 15% of other triglycerides, dissolves in the carbon dioxide and vice versa.

The procedure is followed as explained previously, with the exception that the reactor 2 does not comprise a turbine 22. The carbon dioxide feed is shut off before carrying out the reciprocal dissolving of the cocoa butter with the carbon dioxide. During said dissolving, the temperature is 30° C. in the first reactor 2, and the initial pressure in said first reactor 2 is 250 bar, or 25 MPa. Expansion is carried out by opening the valve 8. The depressurizing means is a nozzle 12 with a circular orifice of 340 μm diameter and 3 mm in length. The expansion with valve 5 closed and valve 8 open, takes about five minutes or 300 seconds. The temperature of the fluid mixture after heating by the device 10 upstream of the nozzle is 80° C. The temperature in the second reactor 3 is 15° C., and the pressure is 5 bar (or 0.5 MPa). The two reactors 2 and 3 are then depressurized, after having shut the valve 8. Crystals of cocoa butter 20 and 21 are recovered in each of the two reactors, and their respective polymorphism is examined by DSC (Differential Scanning Calorimetry). The temperature at the end of melting of the crystals, or “end-set point”, is measured in order to characterize the crystals. The DSC measurement protocol is the one described in the article “Phase transitions and polymorphism of cocoa butter” published in JAOCS vol 75 (4) 425-439, 1998, and of which a portion is briefly resumed below: the apparatus is a Perkin-Elmer DSC-7 apparatus, and the sample analysis protocol is as follows: start at −5° C. followed by heating at the rate of 5° C. per minute. The temperature observed at the end of melting for the particles 20 of the first reactor 2 is 33.1° C., mainly corresponding to the form V most particularly desired. The temperature observed at the end of melting for the particles 21 of the second reactor 3 is lower than 28° C., mainly corresponding to the unstable forms I, II, III, and IV.

Said crystals 20 are advantageously used for seeding chocolate in the production of chocolate by tempering. Their crystalline polymorphism is ideal for the method, as explained previously.

1.-21. (canceled)

22. A method for producing particles, at least partially crystallized, under pressure, comprising reciprocal dissolving of at least one fluid under higher or slightly lower pressure than its critical pressure, with at least one substance to be treated, in a dissolving zone, followed by rapid depressurization with at least one depressurizing means, downstream of the dissolving zone, so as to collect said particles, at least partially crystallized, in a collecting zone located downstream of said depressurizing means, said substance to be treated comprising fat, wherein said method further comprises a collecting of particles at least partially crystallized in the dissolving zone.

23. The method as claimed in claim 22, wherein the collecting zone is a conversion zone.

24. The method as claimed in claim 22, wherein the fluid contains at least one cosolvent which is added to the fluid and a quantity of 1 to 5% by weight.

25. The method as claimed in claim 22, wherein the fluid contains at least one cosolvent which is an alcohol such as ethanol.

26. The method as claimed in claim 22, wherein the fluid, in gaseous form, and the particles, in solid form are separated in the dissolving zone and/or in the collecting zone.

27. The method as claimed in claim 22, wherein at least one stirring means is used to stir the substance to be treated and the fluid during their reciprocal dissolving in the dissolving zone so as to promote the dissolving, before the depressurization.

28. The method as claimed in claim 22, wherein said pressurized fluid is selected from the group consisting of carbon dioxide, short-chain alkanes, nitrous oxide and nitrogen, and mixtures thereof.

29. The method as claimed in claim 22, wherein said pressurized fluid is carbon dioxide.

30. The method as claimed in claim 22, wherein said pressurized fluid is in the supercritical state.

31. The method as claimed in claim 22, wherein the temperature in the dissolving zone is controlled so that, during said method, the fluid does not crystallize after expansion, and so that the at least partially crystallized particles do not melt.

32. The method as claimed in claim 22, wherein the substance to be treated is placed in excess in the dissolving zone before the method according to the invention is put into practice.

33. A continuous chocolate tempering method comprising the method as claimed in claim 22.

34. Particles crystallizable by the method as claimed in claim 22.

35. Particles of fat crystallizable by the method as claimed in claim 22.

36. Particles of cocoa butter crystallizable by the method as claimed in claim 22.

37. A device for producing particles at least partially crystallized, under pressure, comprising at least a first reactor suitable for reciprocal dissolving of at least one substance to be treated with at least one fluid under higher or slightly lower pressure than its critical pressure, followed by at least one depressurizing means, downstream of the first dissolving reactor, which supplies at least one second reactor suitable for collecting at least partially crystallized particles, downstream of said depressurizing means, wherein the first dissolving reactor is also suitable for collecting at least partially crystallized particles.

38. The device as claimed in claim 37, wherein said second reactor is a reactor wherein at least one conversion of a substance to be treated can take place.

39. The device as claimed in claim 37, wherein the device comprises at least one means for mixing a cosolvent with the fluid.

40. The device as claimed in claim 37, wherein the depressurizing means is selected so as to adjust the depressurization time.

41. The device as claimed in claim 37, wherein said device comprises at least one stirring means in the first reactor.
